(19) United States
(12) Patent Application Publication
(10) Pub. No.: US 2007/0126202 A1
(43) Pub. Date: Jun. 7, 2007

(54) Wheelchair with retractable storing leg rests

(76) Inventor: Gary Edward Crosby II, Kalamazoo, MI (US)

Correspondence Address: Gary E. Crosby II, 1228 Whites Rd., Kalamazoo, MI, 49008, US

(21) Appl. No.: 11/294,202

(22) Filed: Dec. 6, 2005

(51) Int. Cl. A61G 5/10

(52) U.S. Cl. 280/304.1

(57) ABSTRACT

A wheelchair which facilitates the storage of retractable leg rests within its side frames. These leg rest are independently able to be in the “stored” or “use” positions and continue to allow the wheelchair frame to be folded. The leg rest members are telescopically mounted to each other and allow for leg length adjustment on this telescopic slide. This leg rest assembly has angle adjustability to suit multiple angles of the occupant's knees for comfort.

### CROSS REFERENCE TO RELATED APPLICATION

I claim benefit from the provisional patent filed Nov. 29, 2004. No. 60/631,271. This provisional patent reveals the nature of a wheelchair side frame with a cavity that allows storage space for an attached retractable leg rest assembly, while maintaining the folding capabilities of the frame.

### STATEMENT REGARDING FEDERALLY SPONSORED RESEARCH OR DEVELOPMENT

Not Applicable.

### BACKGROUND OF THE INVENTION

1. Field of the Invention

This invention lies in the field of wheelchairs and more specifically the storage of leg rest assemblies associated with said wheelchairs.

2. Description of Prior Art

The majority of prior art wheelchairs provide no storage capabilities for the associated leg rest assemblies. The leg rests for these chairs must be completely removed from the wheelchair during patient transfers or transportation of the wheelchair. These removable leg rests are then easily lost or difficult for the wheelchair user to replace on the wheelchair frame. The prior art leg rest typically must be swung out to the side of the chair for removal or to make room for patient transfers. In tight quarters, as in a bathroom, there is no room for the leg rest to be swung out and removed, and therefore place users at risk for falling over the leg rest assemblies. The prior art leg rest are supported on hangers which have been proven to cause injury to wheelchair users.

### BRIEF SUMMAR OF THE INVENTION

This application is seeking a patent for a wheelchair which has retractable storing leg rest, that store within the side frame of the wheelchair. This design will allow the leg rests to be moved into the storage/use positions, by the wheelchair user or care giver. The design also allows the leg rests to be kept with the wheelchair at all times, to prevent loss or multiple trips from the car to the house during transportation. The design has space made in the side frame for storage of the leg rest via a track system, which enable the wheelchair to maintain its ability to fold, while maintaining a proper ergonomic alignment with the wheelchair users knee joint. In large health facilities there are multiple brands of wheelchairs with multiple styles of leg rests, these are not interchangeable. In these facilities the retractable leg rests will save time for the care givers and make the users safer. Safer by having leg rests available when dependant users are pushed by care givers and having legs safely out of harms way.

This wheelchair frame may be made out of square and/or tubular metal stock as required by the differential load placed on the frame dependant upon the weight of the wheelchair user. The testing limitations are specified by the guidelines set by the U.S. FDA.

Non-frame components will be made of a combination of metal, plastic and rubber.

### BRIEF DESCRIPTION OF THE SEVERAL VIEWS OF THE DRAWING

Figure One shows the wheelchair frame assembled. The components portrayed are: 100 back upright, 230 seating surface, 220 seat rail, 150 opening in side frame for leg rest storage, 190 bottom frame rail, 180 mounting surface for front caster, 20 leg rest upper segment, 90 leg rest lower segment, 260 footplate, 160 front frame support, 110 rear wheel mounting surface, 250 arm rest, 240 back, and 5 the track system.

FIG. 2 portrays an individual side frame and components: 100 back upright, 210 arm rest attaching surface, 130 upper frame rail, 200 brake attaching surface, 110 rear wheel attaching surface, 190 bottom frame rail, 180 front caster attaching surface, 150 opening for leg rest storage which contains 5 the leg rest track system.

FIG. 3 portrays the medial aspect of a side frame. This figure includes a view of 170 the cross-brace which connects the two side frames of the wheelchair and allows it to fold.

FIG. 4 shows a close up of the leg rest assembly. This figure reveals components: 30 the superior articulating end of the upper leg rest segment, which will articulate with the track system, 10 the positional locking joint of the upper leg rest segment, 30 the lower leg rest segment, 60 the locking mechanism for the telescopic leg rest assembly, 70 the reinforced side wall of the telescopic mechanism, 80 the movable stops for the telescopic assembly to stop the leg rest from extending too far, and 50 which is the stop that prevents the leg rest assembly from coming off the chair.

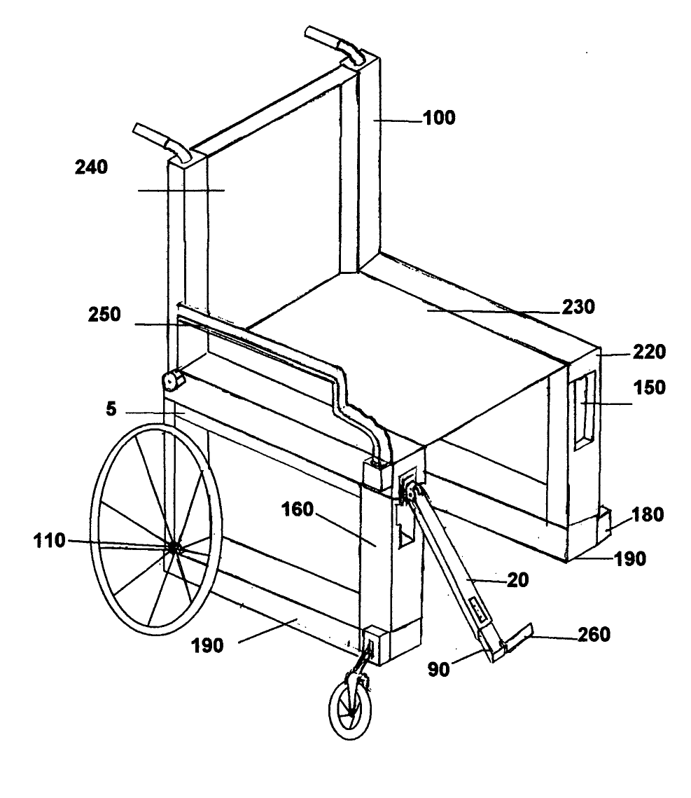

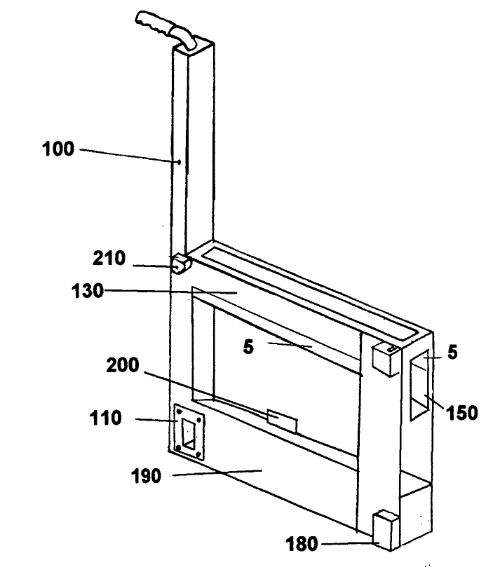

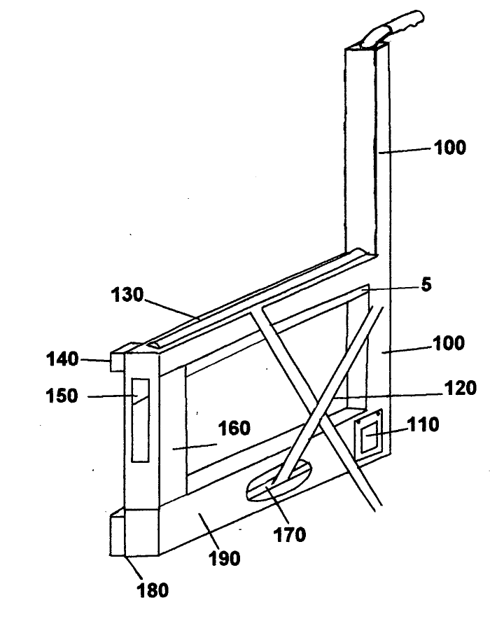

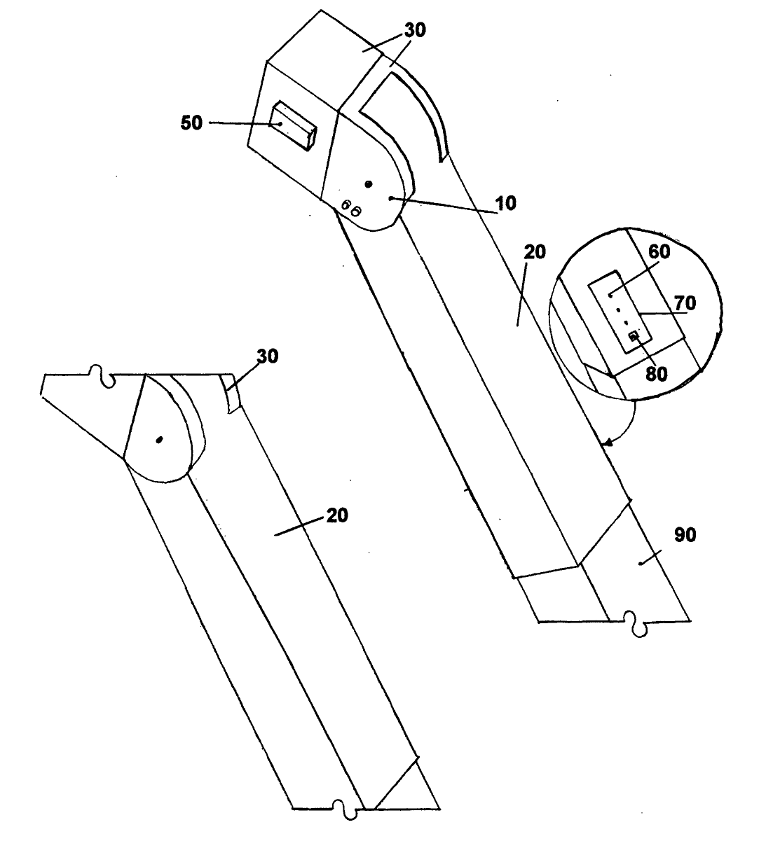

### DETAILED DESCRIPTION OF THE INVENTION

This invention pertains to the art of wheelchairs and more particularly to the leg rest and side frame of said wheelchair. The wheelchair consists of two side frames, a seating surface, a back surface, two large rear wheels, two front caster wheels, two rear wheel brakes, two leg rest assemblies, a foldable cross brace which attaches said sides. Each side frame consists of a bottom frame rail, a top frame rail, a back upright, a medial front support, a lateral front support, a mounting surface for the bottom of the foldable cross-brace on the bottom frame rail, a mounting surface for a rear wheel brake, a mounting surface for a rear wheel and a front caster. Each side frame also contains a longitudinal space which allows for storage of the leg rest assembly responding to that particular side of the frame, via a track system. This side frame space has a track system which ensures that the leg rest assembly can be retracted into the side frame for storage or extended for use. Each leg rest contains an upper segment and lower segment with a foldable footplate at its distal end. The leg rest assembly is a telescopic system which allows the leg rest to fully fit into the side frame opening. The leg rest footplate will also fold to allow it to fit within the side frame. The leg rest assemblies superior attachment to the slide track has angle adjustability in regards to the user's knees to support the user's leg in multiple angles.

1. A wheelchair comprising:
First and second spaced apart sides, each of the said sides having a cavity/opening; a seat and back extending between said sides; and first and second leg rest assemblies, said first leg rest assembly being movably mounted in said first side cavity/opening, said second leg rest assembly being movably mounted in said second cavity/opening, said first and second leg rest assemblies being independently fully extendable into said first and second cavities, respectively, for storage and being extendable from said cavities for use by an occupant of the wheelchair; said first and second sides also have attachment surfaces for rear wheels and front casters; said first and second sides have attachment surfaces for rear wheel brakes; said first and second sides have attachment surfaces for arm rests.

2. The wheelchair according to claim 1, wherein said sides comprise an opening within the sides.

3. The wheelchair according to claim 1, wherein each of said leg rest assemblies includes a base member, an upper leg, and a lower leg, said upper legs pivotally mounted to said base members, said lower legs mounted to said upper legs, and said base members movable mounted in said openings.

4. The wheelchair according to claim 3, wherein said base members are movable mounted in said cavities/openings on a rail/track.

5. The wheelchair according to claim 3, wherein said lower leg are telescoping received in and extendable from said upper legs wherein said lower legs may be at least partially retracted into said upper legs.

6. The wheelchair according to claim 3, wherein each of said leg rest assemblies includes a pivotally mounted footplate mounted to lower leg rest, wherein said footplate may be folded against said lower legs to stored positions.
